(19) United States
(12) Patent Application Publication
(10) Pub. No.: US 2005/0034151 A1
(43) Pub. Date: Feb. 10, 2005

(54) System and method of integrating video content with interactive elements

(75) Inventor: Nathan S. Abramson, Cambridge, MA (US)

Correspondence Address: LAHIVE & COCKFIELD, LLP., 28 STATE STREET, BOSTON, MA, 02109, US

(73) Assignee: Maven Networks, Inc., Cambridge, MA (US)

(21) Appl. No.: 10/637,924

(22) Filed: Aug. 8, 2003

(51) Int. Cl. H04N 7/025; H04N 5/445; H04N 7/16; H04N 7/10

(52) U.S. Cl. 725/32; 725/135; 348/563; 715/500.1

(57) ABSTRACT

A client system for integrating interactivity with video includes a mass storage device, a download manager, and a presentation manager. The download manager retrieves and stores in mass storage a first file comprising video content and a second file comprising an interactive element. The presentation manager retrieves the first file, displays video content represented by the first file, retrieves the second file, and displays the interactive elements semi-transparently over the video content. Related methods and articles of manufacture are also disclosed.

### FIELD OF THE INVENTION

The present invention relates to interactive video applications and, more particularly, to systems and methods for integrating video content with interactive elements.

### BACKGROUND OF THE INVENTION

The worldwide network of computers commonly known as the “Internet” has two compelling advantages over traditional media as a selling tool. Those advantages are the immediacy of the media and the interactivity of the media. A website is able to present to a potential customer photos, audio clips, and streaming video that exhibit products and services to a potential customer. In addition, a website may receive input from the user to see other aspects of a proposed product or service or to place an order.

To date, however, integration of interactivity and visual immediacy have been limited. In particular, it would be desirable to have video integrated with interactive elements that are related to the subject matter of the video displayed to a potential customer. Such a system would benefit from the visual immediacy of video while using interactive elements to cross out other products and services related to the video. The present invention addresses this need.

### BRIEF SUMMARY OF THE INVENTION

The present invention provides a system and associated methods for displaying video content to a user and integrating with the video content one or more interactive elements that are displayed semi-transparently over the video. These interactive elements may be used to offer products and services to the viewer of the video. The products and services may be related to the subject matter of the video that is being displayed.

In one aspect, the present invention is a client system integrating interactivity with video. The client system includes a mass storage device, a download manager, and a presentation manager. The download manager retrieves and stores the mass storage device of first file, and a second file comprising an interactive element. The presentation manager retrieves the first file from mass storage, displays with a standard media player application video content represented by the first file, retrieves the second file from mass storage, and displays with a standard media player application the interactive element semi-transparently over the video content. In some embodiments, the mass storage device is a redundant array of independent disks or a network storage solution. In further embodiments, the download manager retrieves one of the files from a server and another of the files from a peer-to-peer network.

In another aspect, the invention is a method for integrating interactivity with video. The method includes the steps of retrieving from mass storage of first file, displaying with a standard media player application video content represented by the first file, retrieving the second file from mass storage, and displaying with a standard media player application semi-transparently over the displayed video content an interactive element represented by the second file. The file representing video content is retrieved from server. In other embodiments the file representing video content is retrieved from a peer-to-peer network. In still further embodiments, the file representing video content is retrieved from a multicast network.

In still another aspect, the invention is an article of manufacture, having embodied thereon computer-readable program means for integrating interactivity with video. The article of manufacture includes computer-readable program means for retrieving from mass storage a first file, computer-readable program means for displaying with a standard media player application video content represented by the first file, computer-readable program means for retrieving a second file from mass storage, and computer-readable program means for displaying with a standard media player application semi-transparently over the displayed video content an interactive element represented by the second file.

### BRIEF DESCRIPTION OF THE DRAWINGS

The invention is pointed out with particularity in the appended claims. The advantages of the inventions described above, together with further advantages of the invention, may be better understood by referring to the following description in conjunction with the accompanying drawings, in which:

FIG. 1 is a block diagram of one embodiment of a client-server system in which the present invention can be used;

FIG. 2 depicts a block diagram of an embodiment of a computer useful as a client node;

FIG. 3 depicts a block diagram of an embodiment of a client node useful in the present invention;

FIG. 4 is a flowchart depicting one embodiment of the steps taken to download a channel of content;

FIG. 5 is a flowchart depicting one embodiment of the steps taken to display an interactive element semi-transparently over video.; and

FIG. 6 is a schematic diagram depicting clipping behavior exhibited by some operating systems.

### DETAILED DESCRIPTION OF THE INVENTION

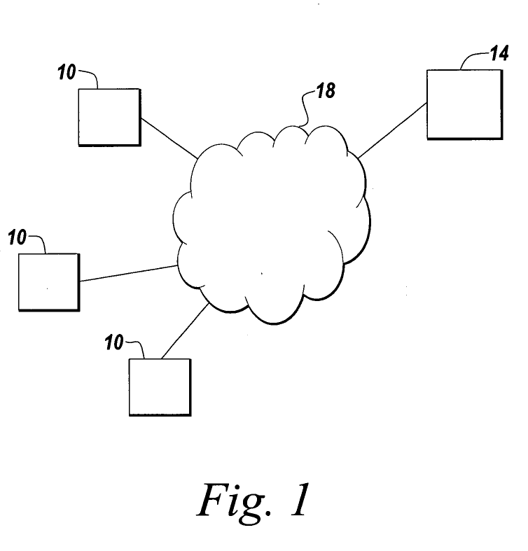

Referring now to FIG. 1, in brief overview, one embodiment of a client-server system in which the present invention may be used is depicted. A first computing system (client node) 10 communicates with a second computing system (server node) 14 over a communications network 18. In some embodiments the second computing system is also a client node 10. The topology of the network 18 over which the client nodes 10 communicate with the server nodes 14 may be a bus, star, or ring topology. The network 18 can be a local area network (LAN), a metropolitan area network (MAN), or a wide area network (WAN) such as the Internet.

The client and server nodes 10, 14 can connect to the network 18 through a variety of connections including standard telephone lines, LAN or WAN links (e.g., T1, T3, 56 kb, X.25), broadband connections (ISDN, Frame Relay, ATM), and wireless connections. Connections can be established using a variety of communication protocols (e.g.,.TCP/IP, IPX, SPX, NetBIOS, Ethernet, ARCNET, Fiber Distributed Data Interface (FDDI), RS232, IEEE 802.11, IEEE 802.11a, and direct asynchronous connections). Other client nodes and server nodes (not shown) may also be connected to the network 18.

The client node 10 can be any device capable of displaying video and interactive elements and capable of operating in accordance with the protocol disclosed herein. The client node 10 may be a personal computer, windows-based terminal, network computer, information appliance, X-device, workstation, mini computer, personal digital assistant or cell phone.

For embodiments in which client nodes 10 are computers, they may be based on the Pentium family of processors manufactured by Intel Corp. of Mountain View, Calif., which includes the Pentium, Pentium II XEON, Celeron, and Pentium III microprocessors, the Power PC line of processors manufactured by Motorola Corp. of Schaumburg, Ill., the Crusoe line of processors manufactured by TransMeta Corp. of Santa Clara, Calif. In these embodiments, the client node 10 can operate under the control of a variety of operating systems including, but not limited to, WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash., MacOS, manufactured by Apple Computer of Cupertino, Calif., Java, UNIX, or Linux.

Similarly, the server node 14 can be any computing device that stores files representing video and interactive elements and is capable of interacting using the protocol disclosed herein. The server node 14 can be provided as a group of server systems logically acting as a single server system, referred to herein as a server farm. In one embodiment, the server node 14 is a multi-user server system supporting multiple concurrently active client connections. Like the client nodes 10, server nodes 14 may be computers based on the Pentium family of processors manufactured by Intel Corp. of Mountain View, Calif., which includes the Pentium, Pentium II XEON, Celeron, and Pentium III microprocessors, the Power PC line of processors manufactured by Motorola Corp. of Schaumburg, Ill., the Crusoe line of processors manufactured by TransMeta Corp. of Santa Clara, Calif. The server node 14 may operate under the control of a variety of operating systems including, but not limited to, WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash., MacOS, manufactured by Apple Computer of Cupertino, Calif., Java, UNIX, or Linux.

In other embodiments, the client node 10 may have different processors, operating systems, and input devices consistent with the device. For example, in one embodiment the client node is a Zire 71 personal digital assistant manufactured by Palm, Inc. In this embodiment, the Zire 71 operated under the control of the PalmOS operating system and includes a stylus input device as well as a five-way navigator device.

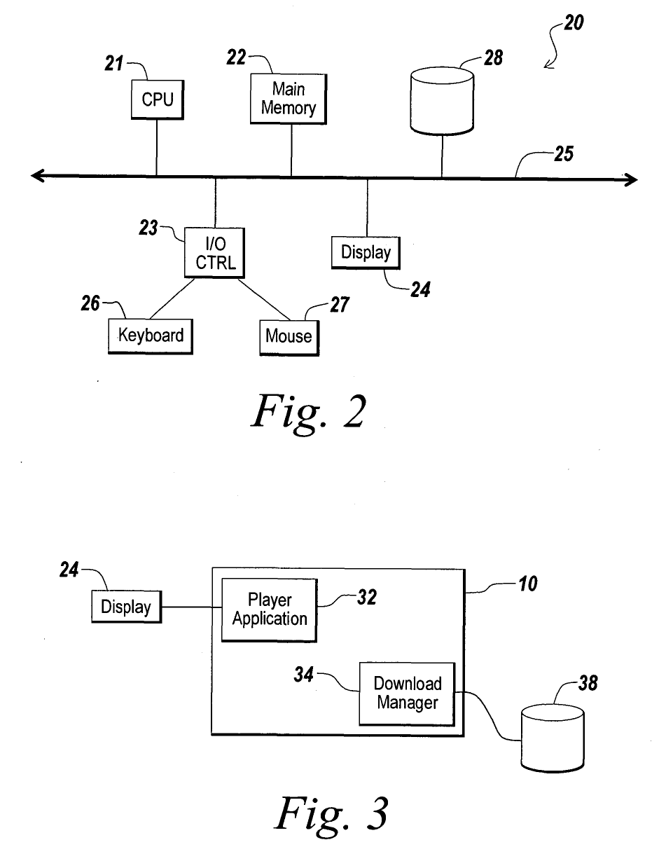

FIG. 2 depicts a block diagram of a typical computer 20 that may be used as a client node 10 or server node 14. As shown in FIG. 2, the computer 20 includes a central processor 21, a main memory unit 22 for temporarily storing programs and/or data, an input/output (I/O) controller 23, a display device 24, and a data bus 25 coupling these components to allow them to communication with each other. The data bus 25 may be a VESA bus, a VESA VL bus, an ISA bus, an EISA bus, a PCI bus, a NuBus, or a MicroChannel Architecture bus. In some embodiments, the display device 24 communicates with the data bus 25 via a video card, such as the Radeon 7000 Mac Edition PCI video card, manufactured by ATI Technologies of Santa Clara, Calif. The main memory unit 22 may include both random access memory (RAM) and read only memory (ROM) chips. The computer 20 typically also has one or more input devices, such as a keyboard 26 and a mouse 27 connected to the I/O controller 23.

As shown in FIG. 2, the computer 20 typically also has a hard disk drive 28. The computer may optionally provide other storage devices (not shown in FIG. 2) such as a floppy disk drive for receiving floppy disks such as 3.5-inch or 5.25-inch disks, a CD-ROM drive, a CD-R drive, a CD-RW drive, a DVD-ROM drive, or tape drives of various formats. In still other embodiments, the computer 20 may provide USB connections to receive handheld USB storage devices such as the USB Flash Drive line of devices manufactured by Twintech Industry, Inc. of Los Alamitos, Calif.

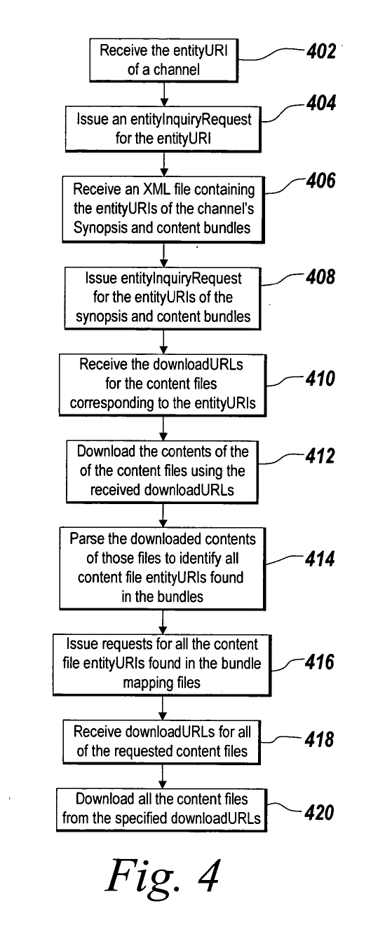

As shown in FIG. 3, a client node 10 useful in connection with the present invention includes a player application 32 and a download manager 34. The player application 32 and the download manager 34 may be provided as software applications permanently stored on a hard disk drive 28 and moved to main memory 22 for execution by the central processor 21. In these embodiments, the player application 32 and the download manager may be written in any one of a number of suitable programming languages, such a PASCAL, C, C+, C++, C#, or JAVA and may be provided to the user on articles of manufacture such as floppy disks, CD-ROMS, or DVD-ROMs. Alternatively, the player application 32 and the download manager 34 may be downloaded from a server node 14 by the user.

In other embodiments, the player application 32 and the download manager 34 may be provided as special-purpose hardware units dedicated to their respective functions. In these embodiments, the player application 32 and the download manager 34 may be provided as application-specific integrated circuits (ASICs), field-programmable gate arrays (FPGAs), programmable-logic devices (PLDs), programmable array logics (PALs), programmable read-only memories (PROMs), or electrically-erasable programmable read-only memory (EEPROMs).

The download manager 34 downloads and stores locally content to be displayed by the player application 32. Although downloaded data may be stored in any form of persistent storage such as tape media, compact disc media, or floppy disk media, it is preferred that the download manager store downloaded data on a hard drive associated with the client node 10.

Before beginning a detailed discussion of the process used by the download manager 34 for downloading content, a brief introduction of the terms used in this document to identify various forms of content will be helpful. The terms introduced here are: channel; program; shelf; bundle; and content file.

A “channel” refers to an HTML application, e.g. a downloadable “mini web site,” that acts as the “player” for its programs. Channels may be thought of as “mini applications” or “custom players” for “programs,” which are described below. Both channels and programs are represented as directory structures containing content files, similar to the way a web site is structured as a hierarchy of directories and files. When the download manager 34 downloads a channel or program, it downloads a complete directory structure of files. A channel is also the object that owns programs, so if a channel is removed, its corresponding programs are also removed. Every channel is identified by a unique identifier referred to herein as an entityURI. The download manager 34 is made aware of channels when the channel's entityURI is passed through an API call made by an ActiveX object, which can be invoked by JavaScript in a web page. A channel also has an associated object that represents the contents of a version of the channel. During the download of an update to the channel, a new channel version object is created to represent the version of the channel being downloaded. When the new version is completely downloaded, the current channel version object is deleted and the new channel version object becomes the current channel version object. The channel version object includes a version number that is assigned by the source of the channel and is returned in response to a request for information about the channel made by the download manager 34. When the channel source returns a channel version object having a higher version number than the one currently stored by the download manager 34, it indicates to the download manager 34 that a new version of the channel is available for download. The download manager 34 creates a new channel version object and begins to download the new version of the channel.

A “program” is similar in structure to a channel. Like a channel, a program has a version number maintained by its source and the download manager 34 can begin downloading a new version of the program if it detects that the program's version number has increased. Like channels, programs are identified for download through ActiveX API calls. However, these API calls are usually made by the channel itself. A program is associated with a single channel. If the associated channel is removed from the client node 10, the program is removed as well.

As used herein, a “shelf” refers to subdivisions of the programs associated with a channel. When a program is downloaded, the download manager 34 may add the program to a specific shelf of a channel. Shelves represent a level of indirection between channels and programs, i.e., a channel doesn't own programs, instead a channel owns shelves, and the shelves own programs. Shelves are created and removed using ActiveX API's. Every channel has a “default shelf” which is created when the channel is added. In some embodiments, shelves are used to implement different rules for saving programs. For example, programs associated with one shelf may be deleted after one day, while programs associated with another shelf may be saved until the user explicitly deletes them.

As used in this document a “bundle” refers to a virtual directory structure that maps directory names, e.g., “images/logo.gif,” to content files. The mapping is stored as XML in a content file. The content file storing the mapping is referred to as the bundle's descriptor. A bundle can be used in one of four ways: (1) as a synopsis bundle of a program; (2) as a content bundle of a program; (3) as the synopsis bundle of a channel; (4) or as the content bundle of a channel. In every case, a bundle is associated with either a program or a channel and may be stored in a respective program version object or channel version object.

As used in this document, a “content bundle” refers to a set of content files grouped into a virtual directory structure. A content bundle identifies the bulk of the channel or program content, and may be thought of as “the channel” or “the program.” The content bundle identifies each content file identified by the channel and indicates where that file is located in the virtual directory structure. One embodiment of a content bundle is shown below:

index.html ==> http://www.content.com/contentAuthority#7291332
images/logo.gif ==> http://www.content.com/contentAuthority#15930531
images/spacer.gif ==> http://www.content.com/contentAuthority#9399203

The left hand side of each mapping is the name of the file within the content bundle's virtual directory structure. The right hand side of each mapping is the entityURI of a corresponding content file representing a single version of any particular item of content, e.g., an HTML file, an image, a video, etc. If a content file is changed, it is represented as a new content file with a new globally-unique entityURI. Thus, if a content file contained in a channel changes, a completely new content file is reissued and the appropriate content bundle is modified to “point” to the new content file.

As used herein, a content file represents one of the content file entities described above. It keeps track of the URL for getting an actual file, where the file is on the local disk, and how much of the file has been downloaded. Content files are referenced by bundles. Because content files can be shared between channels and programs, a content file might be referenced by more than one bundle. Alternatively, a content file might not be referenced by bundles. For example, in some embodiments when a program is deleted, its content files are not deleted at the same time. This is advantageous in embodiments in which other programs include the same content file. Content files include traditional forms of content, such as video and audio, as well as interactive elements to be displayed to the user. For example, a content file may store an interactive element that offers for sale products or services related to other content in the channel. A specific example of this is video from a magazine source, such as National Geographic or Time Magazine, having an interactive element soliciting magazine subscriptions displayed semi-transparently over the running video.

The three basic elements of the content distribution system: channels; programs; and content files, are referred to herein as entities. Each entity has a globally-unique entityURI, which both uniquely identifies the entity and contains enough information to locate the entity. In one embodiment, an entityURI has the following format:
http://www.mycompany.com/contentAuthority#33958193020193

In this embodiment, the entityURI includes a content source Uniform Resource Locator address (URL), i.e., http://www.mycompany.com/contentAuthority, and an identification code identifying the file, i.e., #33958193020193. In some embodiments, the entityURI is not human-readable. In some embodiments, the entityURI is a URL, i.e., it does not include the “#” symbol separating the identification code from the remainder of the entityURI. In these embodiments, the entityURI may be represented in the following manner: http://www.mycompany.com/contentAuthority/33958193020193. Still further embodiments may include a mixture of both forms of entityURIs.

Although there are several utilities that can represent a directory of files in a single file making it easy to transport an entire directory of files—.ZIP files are widely used in personal computers running a WINDOWS-based operating system and .TAR files are often used on computers running a UNIX-based operating system—this approach is not used in the present invention for two reasons. First, it is possible that several channels or programs will share the same files, for example, multiple programs might all include the same advertisement. Downloading this content multiple times would consume additional time and bandwidth. The second reason for avoiding this approach is that channels and programs may be updated often, sometimes with minor changes. In these cases, the download cost can be minimized by only transporting those files that have changed, without having to transport an entire .ZIP or .TAR file.

FIG. 4 depicts the steps taken by the download manager 34 to download a channel of content. In brief overview, the process for downloading a channel includes the steps of: receiving the entityURI of a channel (step 402); issuing a request for information about the entityURI (step 404); receiving an XML file containing the entityURIs of the channel's synopsis and content bundles (step 406); issuing requests for information about the entityURIs of the synopsis and content bundles; (step 408); receiving an XML file containing the entityURIs for the synopsis and content bundles (step 410); downloading the contents of the files identified by the received entityURIs for the synopsis and content bundles (step 412); parsing the downloaded contents of those files to identify all content file entityURIs found in the bundles (step 414); issuing requests for all the content file entityURIs found in the bundle mapping files (step 416); receiving downloadURLs for all of the requested content files (step 418); and downloading all the content files from the specified downloadURLs (step 420).

Still referring to FIG. 4, and in more detail, the process for downloading a channel begins by receiving the entityURI of a channel (step 402). An exemplary channel entityURI is reproduced below:
http://theartist.tld.net/contentAuthority/channels/TheArtistJukebox

In some embodiments, the entityURI is “pushed” to the download manager 34 by a server node 14. For example, a user of a client node 10 may access a web site that makes a JavaScript call to a function exposed by the download manager 34. That function call passes the entityURI of the channel to be downloaded. In other embodiments, the entityURI may be “pulled” by the client node 10 by, for example, clicking on a hyperlink that delivers to the download manager 34 the entityURI. In still other embodiments the download manager 34 may retrieve entityURIs from an article of manufacture, such as a CD-ROM or DVD-ROM, having the entityURIs embodied thereon.

Once the download manager 34 has the entityURI of a channel, it issues a request for more information about the entityURI of the channel (step 404). Using the exemplary channel entityURI reproduced above, the download manager would issue an HTTP GET request to http://theartist.tld.net/contentAuthority/channels/TheArtistJukebox. In some embodiments, this request is made via an HTTP POST request to the content source identified in the entityURI, i.e., http://www.mycompany.com/contentAuthority. In some of these embodiments, the HTTP POST request includes an XML document including additional information about the request.

Upon receipt of the request, the download manager 34 receives information about the channel transmitted by the content source (step 406). In some embodiments, the content source transmits an XML file to the download manager 34. An exemplary XML received by the download manager in these embodiments is:

```
<contentAuthorityResponse
xmlns=“http://www.tld.net/xml/ns/ContentAuthorityResponse”>
  <channelInfo
entityURI=“http://theartist.tld.net/contentAuthority/channels/TheA
rtistJukebox/channelEntity.xml”
synopsisBundleURI=“http://theartist.tld.net/contentAuthority/Ba53
de4cf68c7cd995cD7c9910d1d1d45.xml”
contentBundleURI=“http://theartist.tld.net/contentAuthority/Ba53d
e4cf68c7cd995cD7c9810d1d1d45.xml”
    version=“1058919065331”
  />
</contentAuthorityResponse>
```

The first field identifies the file as a response to the HTTP GET request issued by the download manager 34. In the example above, the information transmitted to the download manager 34 includes an identification of the entityURI, a “synopsis” of the channel (the synopsisBundleURI) and a content bundle (the contentBundleURI). The example reproduced above includes an identification of the current version of the channel, i.e. version=1058919065331. In some embodiments, the synopsis includes a very small amount of information, such as metadata describing the channel or, in some embodiments, a “teaser” image. Because the synopsis is small, a download manager 34 is able to load this information very quickly. This allows a client node to display information about a channel immediately without waiting to download the content for a channel, which is usually much larger than the synopsis and, therefore, takes longer to download.

The download manager 34 requests more information about the entityURI of the content bundle and the entityURI of the synopsis bundle (step 408). In some embodiments the client node issues these requests as HTTP POST requests. For example, to retrieve information relating to the synopsis bundle, the download manager 34 may issue an HTTP GET request to http://theartist.tld.net/contentAuthority/Ba53de4cf68c7cd995cD7c9910d1d1d45.xml. A similar process is followed for the content bundle. The download manager 34 may issue the requests serially, or it may issue several requests for information in a single HTTP POST request. For embodiments in which the entityURI is a URL (such as in the example above), the download manager 34 issues an HTTP GET request instead of an HTTP POST request. In these embodiments, only a single request is issued at a time. The XML files for the synopsis and the content bundle do not need to be stored on the same server node 14. Thus, in some embodiments, a “synopsis server” and a “content server” may be used to implement the present invention.

In response to the requests, the client node 10 receives information about the synopsis and content files of a particular channel (step 410). An example of the response transmitted to the client node 10 in response to a request for information relating to the content bundle is reproduced below:

```
<contentAuthorityResponse
xmlns=“http://www.tld.net/xml/ns/ContentAuthorityResponse”>
  <contentFileInfo
entityURI=“http://theartist.tld.net/contentAuthority/Ba53de4cf68c
7cd995cD7c9810d1d1d45.xml”
downloadURL=“http://theartist.tld.net/content/channel/Ba53de4cf
68c7cd995cD7c9810d1d1d45.xml.bnd.xml”
    />
</contentAuthorityResponse>
```

The downloadURL, i.e., http://theartist.tld.net/content/channel/Ba53de4cf68c7cd995cD7c9810d1d1d45.xml.bnd. xml, indicates from where the client node 10 can download the bundle's descriptor. In some embodiments, the content source may choose downloadURLs based on load, physical location, network traffic, affiliations with download sources, etc. In some embodiments, the server node 14 responds with URL addresses identifying files for the download manager 34 to download. In some embodiments, the server node 14 uses a “prefetch” algorithm to transmit to the download manager 34 information about related entityURIs about which the server node 14 predicts the download manager 34 will request information in the future.

The download manager 34 then downloads the bundle descriptor (step 412). In the example being followed, the download manager receives:

```
<bundle xmlns=“http://www.tld.net/xml/ns/Bundle”>
  <contentFile
entityURI=“http://theartist.tld.net/contentAuthority//La53de4cf68c
7cd995cD7cb710d1d1d45.xml” name=“images/wave.jpg” />
  <contentFile
entityURI=“http://theartist.tld.net/contentAuthority/La53de4cf68c7
cd995cD7cb810d1d1d45.xml” name=“logos/labelLogo.gif” />
  <contentFile
entityURI=“http://theartist.tld.net/contentAuthority/La53de4cf68c7
cd995cD7cb910d1d1d45.xml” name=“images/top.gif” />
  <contentFile
entityURI=“http://theartist.tld.net/contentAuthority/La53de4cf68c7
cd995cD7cba10d1d1d45.xml” name=“register.js” />
  <contentFile
entityURI=“http://theartist.tld.net/contentAuthority/La53de4cf68c7
cd995cD7cbb10d1d1d45.xml” name=“register.html” />
  <contentFile
entityURI=“http://theartist.tld.net/contentAuthority/La53de4cf68c7
cd995cD7cbc10d1d1d45.xml” name=“playMenu.xsl” />
  ...
</bundle>
```

As described above, and as shown in the example above, a bundle file is an XML file mapping files in a virtual file structure to physical addresses at which the file can be located. The download manager 34 parses the received files to identify all content files required for a channel (step 414). The download manager 34 determines if it has already downloaded any of the identified files. In some embodiments it does this by comparing the entityURI of each identified file with the entityURI of each file the download manager 34 has already downloaded and stored locally.

For each file identified in the bundle that the download manager 34 has not already retrieved, the download manager 34 issues requests more information about each of the files identified (step 416). In some embodiments, these requests are HTTP POST requests. For example, in the example above, the download manager 34 issues an HTTP GET request to http://theartist.tld.net/contentAuthority//La53de4cf68c7cd995cD7cb710d1d1d45.xml to retrieve information about a file that will appear as images/wave.jpg in the virtual file structure the download manager 34 is creating. The content authority responds with information about the file, such as the file type, file size, and URL from which it can be downloaded. This allows the content source to direct the download manager 34 the best source for the content file. In some embodiments, the content source may direct the download manager 34 to another client node 10 instead of to a server node 14.

In response to its requests for more information, the download manager 34 receives information about all of the requested files (step 418). An exemplary response to that request has the following form:

```
<contentAuthorityResponse
xmlns=“http://www.tld.net/xml/ns/ContentAuthorityResponse”>
  <contentFileInfo
entityURI=“http://theartist.tld.net/contentAuthority/Tld.net/
La53de4cf68c7cd995cD7cb710d1d1d45.xml”
downloadURL=“http://theartist.tld.net/fcs/static/networks/tld.net/
publishers/TheArtistJukebox/channelEntity/content/wave.jpg”
    />
</contentAuthorityResponse>
```

This response directs the download manager 34 to download the file wave.jpg from http://theartist.tld.net/fcs/static/networks/tld.net/publishers/TheArtistJukebox/channelEnt ity/content/wave.jpg. The download manager 34 downloads the identified content files (step 420). In some embodiments, the download manager 34 issues one or more HTTP GET calls to download the file's contents. The download manager 34 may keep track of how much of the file has been downloaded, so that if it gets interrupted (a common occurrence when downloading large files), it can resume the download at the point it was interrupted. Once downloaded, the download manager 34 will store the file locally at the client node 10. The download manager 34 retrieves any files that have not already been downloaded and stores them locally. This approach allows a content file to be downloaded only once, but shared by multiple channels and programs on the client node 10. It also allows each individual client to determine which new content files it should download for new versions of channels and programs.

Still referring to FIG. 3, the player application 32 displays media content at the client node 10. The player application displays video on a display 24. The player application 32 displays channels, provides channels with the ability to display video, and provides the user with access to the state of the files downloaded for each channel, i.e., the list of programs and their channels, the respective download states of each file, and other options associated with the files. The player application 32 also displays common user interface elements for all channels. Some examples of common user interface elements include a file management tool tab, a “my channels” tool tab, a recommendation tool tab, and a program information tool tab.

The file management tool tab provides information to the user concerning the channels and programs that have been downloaded to the client node 10, together with the state of the download.

The “my channels” tool tab provides information regarding the list of channels to which the user has subscribed. In some embodiments, this tool tab allows the user to click on a channel to begin display of that channel.

The recommendation tool tab displays a window to the user that allows the user to recommend the currently-playing program to a friend. Recommendations may be sent by e-mail or an instant messaging system. For embodiments in which email is sent, the email may contain a JavaScript that automatically installs the download manager 34 and player application 32 on the friend's computer, subscribe the friend to the channel, and start downloading content for the channel.

The program information tool tab displays to the user information about the currently-playing program. In some embodiments, this information is taken directly from the synopsis bundle of the program.

Since a channel is an HTML application, a channel is free to use any ActiveX control or other media player application to display content, such as Windows Media Player manufactured by Microsoft Corp. of Redmond, Wash., or Real Player manufactured by Real Networks. Inc. of Seattle, Wash. For the purposes of the present invention it is preferred to use an “off-the-shelf” media player, such as Windows Media Player, Real Player, or the Quicktime Player manufactured by Apple Computer of Cupertino, Calif. If the overlay memory contains an image (such as a single frame of video), and the video RAM contains graphical elements, the overall effect is that the graphical elements will appear to be displayed on top of the video. This artifact may be used to display semi-transparently interactive elements over video.

The player application 32 of the present invention takes advantage of a common hardware acceleration for video known as overlay memory. In traditional computer systems, video RAM holds data that directly represents the images displayed on the display 24. Overlay memory refers to memory elements separate from video RAM that store data corresponding to images that will be displayed if video RAM stores a particular bit value, known as a color key. Thus, a video image will read video RAM and render an image corresponding to the data stored in video RAM unless that data is the color key. When the video RAM stores the color key, the video engine reads data from the overlay memory to render video on the display 24. The overall effect is that any data elements stored in video RAM appear to be displayed on top of video.

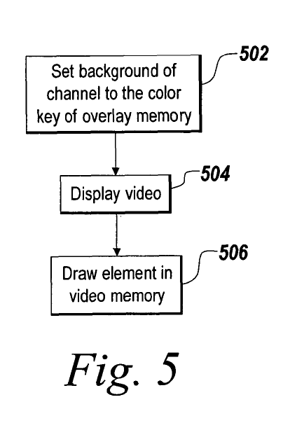

FIG. 5 depicts the steps taken to achieve this effect with standard, “off-the-shelf” media players. A first window, referred to as the “tandem window” is created. An “off-the-shelf” media player component, typically implemented as an ActiveX control, is then instantiated onto this tandem window.” The channel instructs the media player to set the window's entire background color to be that of the color key (step 502). In some embodiments, the channel is precoded with the appropriate value for the color key. In other embodiments, the channel retrieves the appropriate value for the color key via an appropriate API call. The actual color used as the color key varies with the type of video. For Windows media files, the color key is #100010. Other media formats have different color keys, but they all tend to be close to black (#000000).

A second window, referred to as the “channel window”, is created and superimposed on the tandem window. In some embodiments the channel window exactly matches the size and position of the tandem window. In other embodiments, the channel window is offset from the tandem window. In still other embodiments, the size and location of the channel window and the tandem window are synchronized so that the channel window always obscures the tandem window.

The channel then instructs the channel window set its entire background color to be that of the color key (step 502). In some embodiments, the channel may set only a portion of the window's background color to be that of the color key (corresponding to where the video should be displayed). In some embodiments, the channel is precoded with the appropriate value for the color key. In other embodiments, the channel retrieves the appropriate value for the color key via an appropriate API call. The actual color used as the color key varies with the type of video. For Windows media files, the color key is #100010. Other media formats have different color keys, but they all tend to be close to black (#000000).

The channel then instructs the media player component (instantiated into the tandem window in step 0056) to begin displaying video. The media player will store the video data into Overlay Memory. Because the Overlay Memory displays where video RAM contains the color key, the video displayed by the media player will appear in those areas where the channel window has set its color to be the color key, even though the tandem window hosting the media player control is obscured by the channel window.

If the channel then wants to display text, graphics, or other interactive elements over the video, it instructs the channel window to store data corresponding to the interactive elements in video RAM (step 506). Since the colors of the interactive elements are different from the color key, and those elements are positioned over the video area, the end result is that the interactive elements appear to float over the video.

Using the color key allows a channel to overlay graphics onto video, producing a compelling effect. However, the effect can be enhanced greatly by placing graphics or text on a semitransparent overlay. For example, text overlaid on video might be difficult to notice or read. But if that text is framed by a box that allows the video to “shine through” dimly, the resulting effect is much closer to the graphic effects used in high-quality television productions.

This sort of effect can be achieved by placing the text or graphical elements on top of a “mesh” image, in which the pixels alternate between black and the transparent color. The pixels that are the transparent color will take on the color of the background image, which will presumably be the color key and will therefore show the video. The remaining pixels will remain black. Since only half of the pixels are showing the video, the result is that the video is “darkened”, and has the effect of being overlaid by a semitransparent graphical element.

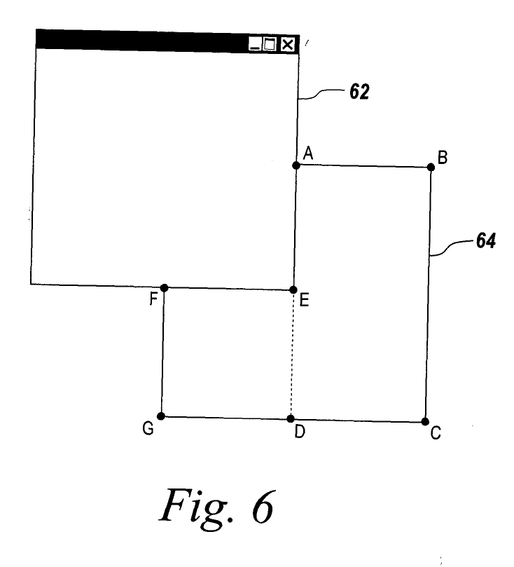

This technique works well in most, but not all, environments. For example, some versions of the WINDOWS operating system will attempt to conserve computing capacity when portions of a window displaying video are obstructed. Referring to FIG. 6, in these embodiments when a first window 62 obscures a portion of a second window 64, a portion of the underlying window 64 will not be displayed. In FIG. 6, the rectangle of window 64 identified by the points DEFGD will not be rendered by the operating system, leaving the user with a truncated video display identified by the points ABCDEA. This poses a problem for the technique identified above because the overlay elements are treated by the operating system as window 62, causing the underlying video to exhibit undesirable clipping artifacts.

In these embodiments, the media player component is instantiated on the tandem window that is, by design, always obscured by the channel window. Because of the above conservation, the media player component may display truncated video or no video at all, thereby posing a problem for the technique identified above.

However, because the WINDOWS operating system allows windows to bedefined with non-rectangular clipping regions (often used to change the “shape” of a window, even to the point of allowing windows to be created with “holes” in them), the issue may be overcome in the following manner. The channel window's clipping region is changed to create small “holes” corresponding to the corners of the media player component in the underlying tandem window. This causes the media player component to be “unobsctructed” at those four corners. If the media player component displays the smallest rectangular region that encompasses all the unobstructed areas, and the unobstructed areas are the four corners, then the media player component will be forced to display video in the entire rectangular region, thereby resulting in an untruncated video display.

In other embodiments, different clipping regions may be used. For example, instead of creating holes in the corners, the channel window may create four long and thin holes corresponding to the four edges (or a single long thin hole the runs the entire perimiter of the rectangle).

The player application may expose a number of functions for playing video files. In some embodiments, these functions are contained by an object represented the player application 32. For example, to play a video, the channel can call an open function exposed by the player application object, passing in the local filename of the video to be played. For example, the following code will open the “video.wmv” file in a program's content bundle:

var player = external.mediaPlayer;
var file = program.getContentFileByName (“video.wmv”);
if (file) {
player.open (file.localFile);
}

Any URL can be specified to the open( ) method, not just filenames. In these embodiments, the channel can play not just locally cached files, but also files on the internet or even streaming media.

The following additional commands may be provided by the player application object to control the video:

| | |
|---|---|
| play( ), stop( ), pause( ) | Plays, stops, or pauses the video |
| fastForward( ), | Seeks through the video at high speed. |
| fastReverse( ) | |
| frameForward( ), | Moves the video frame by frame forward or |
| frameReverse( ) | backwards |
| setPosition(seconds) | Sets the video to be positioned at the specified |
| | number of seconds from the beginning. The |
| | number of seconds may be fractional. |
| setMute(mute) | The value of mute should be 1 or 0, where 1 |
| | means mute any audio coming from the player, |
| | and 0 means unmute. |
| setVolume(volume) | Sets the volume of any audio coming from |
| | the player, where 0 is silence and 100 is full |
| | volume. |

As noted above, the player application can expand the video to fill the window. In some embodiments, the player application 32 will maintain the aspect ratio of the video, which means that there may be a “letterbox” effect in which the top and bottom or the sides will show no video. In these embodiments, the video remains centered in the window. The channel can specify the position of the video within the window edges. This may done with the following function presented by the player application object.

| | |
|---|---|
| setInsets(leftInset, topInset, | Sets the border for the video to be the |
| rightInset, bottomInset) | specified number of pixels away from the |
| | window's edge. |

In some embodiments, as media is being opened and played, it generates asynchronous callbacks that the channel may want to see. These callbacks are sent as events to the “external” object, so the channel can capture one of these events by defining a function named “external:: {eventName}”. The following describes the various callbacks. Each callback passes back the “mediaURL” that was specified in the “open( )” command.

external::mediaInfoReceived(mediaInfo,mediaURL)

This is called after the media is opened, but before it is played. After the channel calls open( ) and that call returns, some time might pass before the player is able to open the media and examine it to find out some basic information. Once it does, it fires this event.

| | |
|---|---|
| overlayColor | The color key that should be used for this video. |
| | The color key is of the form “RRGGBB”, where RR, |
| | GG, and BB are hexadecimal digits. For example, |
| | a windows media file would have a color key |
| | of “100010”. Don't forget to prepend the |
| | “#” character when using this in HTML. |
| width | The height of the media, in pixels |
| height | The height of the media, in pixels |
| duration | The duration of the media, in seconds |
| canPlay | 1 if the mediaPlayer.play( ) command can be used |
| | with this media, 0 if not |
| canStop | 1 if the mediaPlayer.stop( ) command can be used |
| | with this media, 0 if not |
| canPause | 1 if the mediaPlayer.pause( ) command can be used |
| | with this media, 0 if not |
| canFastForward | 1 if the mediaPlayer.fastForward( ) command can |
| | be used with this media, 0 if not |
| canFastReverse | 1 if the mediaPlayer.fastReverse( ) command can |
| | be used with this media, 0 if not |
| canFrameForward | 1 if the mediaPlayer.frameForward( ) command can |
| | be used with this media, 0 if not |
| canFrameReverse | 1 if the mediaPlayer.frameReverse( ) command can |
| | be used with this media, 0 if not |
| canSetPosition | 1 if the mediaPlayer.setPosition( ) command can |
| | be used with this media, 0 if not |

external::playStateChanged(playState,mediaURL)

As the media player opens and plays a media selection, it can go through several “play states”. The channel may wish to display these play states to the user to give some idea of what the player is doing. This is especially true for streaming media, where the “buffering” or “waiting” play states tell the user that something is going on even if no video is playing.

The names of the play states may vary between media types. However, all media types will generate a “mediaEnded” play state when the media finishes playing, which may be very useful to some channels.

external::mediaStoppedByUser(mediaURL)

This is called if the playback of media is stopped explicitly by the user (presumably by pressing the “stop” button). This allows the channel to distinguish between media stopping because the user requested it, or because it reached the end on its own.

external::mediaPositionChanged(seconds,mediaURL)

As the media plays, this callback updates the channel with the current position of the player within the media. The position is specified in seconds (which may be fractional).

While the invention has been shown and described with reference to specific preferred embodiments, it should be understood by those skilled in the art that various changes in form and detail may be made therein without departing from the spirit and scope of the invention as defined by the following claims.

1. A client system integrating interactivity with video, the client system comprising:
a mass storage device;
a download manager retrieving and storing in the mass storage device a first file comprising video content and a second file comprising an interactive element; and
a presentation manager retrieving the first file from mass storage, displaying with a standard media player application video content represented by the first file, retrieving the second file from mass storage, and displaying with a standard media player application the interactive element semi-transparently over the video content.

2. The client system of claim 1 wherein the mass storage device comprises a redundant array of independent disks.

3. The client system of claim 1 wherein the mass storage device comprises a network storage solution.

4. The client system of claim 1 wherein the download manager retrieves one of the first file and the second file from a server and the other of the first file and second file from a peer-to-peer network.

5. The client system of claim 1 wherein the download manager retrieves one of the first file and the second file from a server and the other of the first file and second file from a multicast network.

6. The client system of claim 1 wherein the download manager comprises a thread process.

7. The client system of claim 1 wherein the download manager comprises one of the group consisting of an ActiveX control, a JAVA applet.

8. The client system of claim 1 wherein the presentation manager comprises a threaded process.

9. The client system of claim 1 wherein the presentation manager comprises a Windows Media Player application.

10. A method for integrating interactivity with video, the method comprising the steps of:
(a) retrieving from mass storage a first file;
(b) displaying with a standard media player application video content represented by the first file;
(c) retrieving a second file from mass storage; and
(d) displaying with a standard media player application semi-transparently over the displayed video content an interactive element represented by the second file.

11. The method of claim 10 further comprising the steps of:
(a) retrieving from a server a first file representing video content; and
(b) storing the first file in mass storage.

12. The method of claim 11 further comprising the steps of:
(a) retrieving from a peer-to-peer network a second file representing an interactive element; and
(b) storing the second file in mass storage.

13. The method of claim 11 further comprising the steps of:
(a) retrieving from a multicast network a second file representing an interactive element; and
(b) storing the second file in mass storage.

14. The method of claim 11 further comprising the steps of:
(a) retrieving from a peer-to-peer network a second file representing an video content; and
(b) storing the second file in mass storage.

15. The method of claim 10 further comprising the step of receiving user input via the displayed interactive element.

16. The method of claim 10 further comprising the steps of:
(a) identifying a file for retrieval;
(b) determining if the identified file exists in mass storage; and
(c) retrieving the file only if it is missing from mass storage.

17. An article of manufacture having embodied thereon computer-readable program means for integrating interactivity with video, the article of manufacture comprising:
(a) computer-readable program means for retrieving from mass storage a first file;
(b) computer-readable program means for displaying with a standard media player application video content represented by the first file;
(c) computer-readable program means for retrieving a second file from mass storage; and
(d) computer-readable program means for displaying with a standard media player application semi-transparently over the displayed video content an interactive element represented by the second file.

18. The article of manufacture of claim 17 further comprising:
(a) computer-readable program means for retrieving from a server a first file representing video content; and
(b) computer-readable program means for storing the first file in mass storage.

19. The article of manufacture of claim 18 further comprising:
(a) computer-readable program means for retrieving from a peer-to-peer network a second file representing an interactive element; and
(b) computer-readable program means for storing the second file in mass storage.

20. The article of manufacture of claim 18 further comprising:
(a) computer-readable program means for retrieving from a multicast network a second file representing an interactive element; and
(b) computer-readable program means for storing the second file in mass storage.
